(19) United States
(12) Patent Application Publication
(10) Pub. No.: US 2025/0305290 A1
(43) Pub. Date: Oct. 2, 2025

(54) SYNTHETIC SHINGLES

(71) Applicant: Dow Global Technologies LLC, Midland, MI (US)

(72) Inventors: Yijian Lin, Pearland, TX (US); Yushan Hu, Pearland, TX (US); Viraj Shah, Pearland, TX (US)

(73) Assignee: Dow Global Technologies LLC, Midland, MI (US)

(21) Appl. No.: 19/092,464

(22) Filed: Mar. 27, 2025

Related U.S. Application Data
(60) Provisional application No. 63/571,610, filed on Mar. 29, 2024.

(51) Int. Cl. E04D 1/20; C08K 3/26; C08L 23/06

(52) U.S. Cl. CPC E04D 1/20; C08K 3/26; C08L 23/06; C08K 2003/265; C08L 2205/025; C08L 2205/03; C08L 2207/062; C08L 2207/066

(57) ABSTRACT

According to some embodiments, a synthetic shingle may comprise a polymer blend. The polymer blend may comprise an elastomer, a plastomer, or both, the elastomer, the plastomer, or both having a density of from 0.855 to 0.905 g/cc; an inorganic filler; a functionalized polyolefin comprising: a polyolefin grafted with ethylenically unsubstituted dicarboxylic acid or a derivative thereof; or a polyolefin comprising at least one α-olefin copolymerized with ethylenically unsubstituted dicarboxylic acid or a derivative thereof; a first polyethylene having a density of from 0.935 to 0.970 g/cc; and a second polyethylene having a density of 0.905-0.935 g/cc and a melt index (12) of 3-10 g/10 min.

### CROSS-REFERENCE TO RELATED APPLICATIONS

This application claims the benefit of U.S. Provisional Application Ser. No. 63/571,610 filed Mar. 29, 2024, the contents of which are incorporated in their entirety herein.

### BACKGROUND

### Technical Field

The present disclosure relates to synthetic shingles, and more specifically, to polymer blends utilized for synthetic shingles.

### Background

Synthetic shingles are polymeric tiles used as alternatives to clay/ceramic (also referred to as “slate”) or wooden (also referred to as “shake”) roofing materials. Key properties of these polymeric tiles are price, impact strength (to protect against e.g., hail), and stiffness. Traditional synthetic shingles comprise polyethylene and polypropylene blended with a large amount of filler (e.g., CaCO₃) to increase stiffness while maintaining low cost. However, these traditional synthetic shingles have long been unable to meet desired impact resistance metrics, especially at relatively cold temperatures.

### BRIEF SUMMARY

Embodiments of the present disclosure meet this need by providing synthetic shingles comprising elastomers and/or plastomers and functionalized polyolefins. The inclusion of elastomers and/or plastomers and functionalized polyolefins increases impact resistance, especially at relatively cold temperatures. Additionally, they comprise first and second polyethylenes, which provide the structural rigidity necessary for use as a roofing material.

According to some embodiments, a synthetic shingle may comprise a blend. The blend may comprise an elastomer, a plastomer, or both, the elastomer, the plastomer, or both having a density of from 0.855 to 0.905 g/cc; an inorganic filler; a functionalized polyolefin comprising: a polyolefin grafted with ethylenically unsubstituted dicarboxylic acid or a derivative thereof; or a polyolefin comprising at least one α-olefin copolymerized with ethylenically unsubstituted dicarboxylic acid or a derivative thereof; a first polyethylene having a density of from 0.935 to 0.970 g/cc; and a second polyethylene having a density of 0.905-0.935 g/cc and a melt index (12) of 3-10 g/10 min.

These and other embodiments are described in more detail in the Detailed Description. It is to be understood that both the foregoing general description and the following detailed description present embodiments of the presently disclosed technology, and are intended to provide an overview or framework for understanding the nature and character of the technology as it is claimed.

### DETAILED DESCRIPTION

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomer types.

“Polyethylene” or “ethylene-based polymer” refers to polymers comprising greater than 50% by weight derived from ethylene monomer. This includes polyethylene homopolymers or copolymers (meaning units derived from two or more monomer types). Common forms of polyethylene known in the art include Low-density polyethylene (LDPE); Linear Low-density polyethylene (LLDPE); Ultra Low-density polyethylene (ULDPE); Very Low-density polyethylene (VLDPE); single-site catalyzed Linear Low-density polyethylene, including both linear and substantially linear low density resins (m-LLDPE); Medium Density Polyethylene (MDPE); and High Density Polyethylene (HDPE).

The term “LDPE” may also be referred to as “high-pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see, for example, U.S. U.S. Pat. No. 4,599,392, which is hereby incorporated by reference in its entirety). LDPE resins typically have a density in the range of 0.916 g/cm³ to 0.930 g/cm³.

The term “LLDPE,” includes resin made using Ziegler-Natta catalyst systems as well as resin made using single-site catalysts, including, but not limited to, bis-metallocene catalysts (sometimes referred to as “m-LLDPE”), phosphinimine, and constrained geometry catalysts, and resins made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based copolymers. LLDPEs contain less long chain branching than LDPEs and include the substantially linear ethylene polymers, which are further defined in U.S. Pat. Nos. 5,272,236, 5,278,272, 5,582,923 and 5,733,155 each of which are incorporated herein by reference in their entirety; the homogeneously branched linear ethylene polymer compositions such as those in U.S. Pat. No. 3,645,992 which is incorporated herein by reference in its entirety; the heterogeneously branched ethylene polymers such as those prepared according to the process disclosed in U.S. Pat. No. 4,076,698 which is incorporated herein by reference in its entirety; and blends thereof such as those disclosed in U.S. Pat. Nos. 3,914,342 and 5,854,045 which are incorporated herein by reference in their entirety. The LLDPE resins can be made via gas-phase, solution-phase, or slurry polymerization or any combination thereof, using any type of reactor or reactor configuration known in the art.

The term “HDPE” generally refers to polyethylenes having densities greater than about 0.930 g/cm³ and up to about 0.970 g/cm³, which are generally prepared with Ziegler-Natta catalysts, chrome catalysts or single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy).

As used herein, a “polyolefin” refers to an olefin-based polymer. As used herein, an “olefin,” which may also be referred to as an “alkene,” refers to a linear, branched, or cyclic compound including carbon and hydrogen and having at least one double bond. As used herein, when a polymer or copolymer, e.g., the polyolefin elastomer, is referred to as comprising an olefin, the olefin present in the polymer or copolymer is the polymerized form of the olefin.

As used herein, an “elastomer” refers to a material that will substantially resume its original shape after being stretched. For instance, upon application of a stretching force, an elastomer is stretchable in at least one direction, such as the cross machine direction, and, upon release of the stretching force, contracts/returns to approximately its original dimension. For example, an example elastomer is a stretched material having a stretched length which is at least 50% greater than its relaxed, un-stretched length, and which will recover to within at least 50% of its stretched length upon release of the stretching force. A hypothetical example would be a one (1) inch sample of a material which is stretchable to at least 1.50 inches and which, upon release of the stretching force, will recover to a length of not more than 1.25 inches.

As used herein, a “plastomer” refers to a material comprising the properties of a plastic and an elastomer.

A synthetic shingle may comprise a polymer blend. The polymer blend may comprise: an elastomeric component, an inorganic filler, a functionalized polyolefin, a first polyethylene, and a second polyethylene.

The elastomeric component may comprise an elastomer, a plastomer, or both. Without being limited by theory, the inclusion of an elastomeric component may improve impact resistance, especially at colder temperatures. The elastomer may comprise a polyolefin elastomer. The plastomer may comprise an ethylene α-olefin plastomer. Both elastomers and plastomers may comprise include any polyethylene or polypropylene based elastomer including homogeneously branched ethylene/α-olefin copolymer, propylene/α-olefin interpolymer, and ethylene-propylene-diene monomer rubber (EPDM). Both elastomers or plastomers may be linear, or substantially linear, ethylene/α-olefin copolymers containing homogeneous short-chain branching distributions comprising units derived from ethylene and units derived from at least one olefin comonomer. The olefin comonomer may be an α-olefin comonomer. The α-olefin may be a C₃-C₂₀ linear, branched or cyclic α-olefin. Examples of C₃-C₂₀ α-olefins include propene, 1-butene, 4-methyl-1-pentene, 1-hexene, 1-octene, 1-decene, 1-dodecene, 1-tetradecene, 1-hexadecene, and 1-octadecene. The α-olefins can also contain a cyclic structure such as cyclohexane or cyclopentane, resulting in an α-olefin such as 3-cyclohexyl-1-propene (allyl cyclohexane) and vinyl cyclohexane. Although not α-olefins in the classical sense of the term, certain cyclic olefins, such as norbornene and related olefins, are α-olefins and can be used in place of some or all of the α-olefins described above. Similarly, styrene and its related olefins (for example, α-methylstyrene, etc.) are α-olefins as described herein.

Homogeneously branched ethylene/α-olefin copolymers can be made with a single-site catalyst, such as a metallocene catalyst or constrained geometry catalyst, and typically have a melting point of less than 105° C., such as less than 90° C., less than 85° C., as less than 80° C., or even less than 75° C. The melting point is measured by differential scanning calorimetry (DSC) as described, for example, in U.S. Pat. No. 5,783,638. Illustrative homogeneously branched ethylene/α-olefin copolymers include ethylene/propylene, ethylene/butene, ethylene/1-hexene, ethylene/1-octene, ethylene/styrene, and the like. Illustrative terpolymers include ethylene/propylene/1-octene, ethylene/propylene/butene, ethylene/butene/1-octene, and ethylene/butene/styrene. The copolymers can be random copolymers or block copolymers.

In embodiments, the elastomeric component may have a density of from 0.855 to 0.905 g/cc, such as from 0.855 to 0.865 g/cc, from 0.865 to 0.875 g/cc, from 0.875 to 0.885 g/cc, from 0.885 to 0.895 g/cc, from 0.895 to 0.905 g/cc, or any combination of two or more of these ranges. The elastomeric component may have a melt index of from 1 to 20 g/10 min, such as from 1 to 3 g/10 min, from 3 to 6 g/10 min, from 6 to 8 g/10 min, from 8 to 10 g/10 min, from 10 to 15 g/10 min, from 15 to 20 g/10 min, or any combination of two or more of these ranges. Suitable examples of elastomers include ENGAGE™ (a homogeneously branched, substantially linear ethylene/α-olefin polymer available from The Dow Chemical Company, Midland MI). Suitable examples of plastomers include AFFINITY™ (a homogeneously branched, substantially linear ethylene/α-olefin polymer available from The Dow Chemical Company, Midland MI). Further examples of contemplated elastomers and plastomers include EXACT commercially available from Exxon Chemical Company and TAFMER commercially available from Mitsui Chemical. Japan.

The inorganic filler may comprise any compound which can decrease cost or increase hardness. Suitable inorganic fillers may include CaCO₃, clay, talc, coal ash, carbon black, silica, and glass fibers. In some specific embodiments, the inorganic filler may comprise CaCO₃, such as untreated CaCO₃. Generally, CaCO₃ may provide both filler and hardening properties at low cost. The inorganic filler may have a particle size of from 1 to 500 microns, such as from 1 to 5 microns, from 5 to 10 microns, from 10 to 25 microns, from 25 to 50 microns, from 50 to 100 microns, from 100 to 300 microns, from 300 to 500 microns, or any combination of two or more of these ranges.

As mentioned previously, the polymer blend may comprise a functionalized polyolefin. Generally, the functionalized polyolefin helps to increase the impact resistance of the resultant shingle. The functionalized polyolefin may be a polyolefin grafted with ethylenically unsubstituted dicarboxylic acid or derivative thereof or may be a polyolefin copolymerized with ethylenically unsubstituted dicarboxylic acid or a derivative thereof. The polyolefin may comprise at least one α-olefin, such as a C₂-C₁₄ α-olefin. Contemplated C₂-C₁₄ α-olefins include, by way of example and not limitation, C₂, C₃, C₄, C₅, C₆, C₇, C₈, C₉, C₁₀, C₁₁, C₁₂, C₁₃, or C₁₄. In embodiments, the α-olefin may be ethylene and the functionalized polyolefin may comprise functionalized polyethylene. In embodiments, the polyolefin may comprise LLDPE, HDPE, elastomer, or plastomer. It should be understood that where the functionalized polyolefin comprises elastomer and/or plastomer, the elastomer and/or plastomer of the functionalized polyolefin does not count as part of the elastomeric component.

The polyolefin may be functionalized with an ethylenically unsubstituted dicarboxylic acid or derivative thereof. The functionalized polyolefin may be formed by co-polymerizing the α-olefin with the ethylenically unsubstituted dicarboxylic acid or by grafting the ethylenically unsubstituted dicarboxylic acid onto the already formed polyolefin. The ethylenically unsubstituted dicarboxylic acid or derivative thereof may be selected from maleic anhydride, itaconic anhydride, maleic acid diesters, fumaric diesters, maleic acid monoesters or fumaric acid monoesters, esters of C₁ to C₄ alcohols, maleic acid, itaconic acid, fumaric acid, or mixtures thereof. For example, the functionalized polyolefin, such as a functionalized polyethylene, may include an anhydride functionalized polyolefin, such as maleic anhydride functionalized polyolefin, such as maleic anhydride functionalized polyethylene, such as maleic anhydride grafted polyolefin. The polyolefin may have a functionalization level of 0.5 to 3.0 wt. %, such as from 1.0 to 2.0 wt. %, from 0.5 to 1.0 wt. %, from 1.0 to 1.5 wt. %, from 1.5 to 2.0 wt. %, from 2.0 to 2.5 wt. %, from 2.5 to 3.0 wt. %, or any combination of two or more of these ranges, of the ethylenically unsubstituted dicarboxylic acid or derivative thereof.

The functionalized polyolefin may have a density of from 0.940 to 0.970 g/cc, such as from 0.940 to 0.945 g/cc, from 0.945 to 0.950 g/cc, from 0.950 to 0.955 g/cc, from 0.955 to 0.960 g/cc, from 0.960 to 0.965 g/cc, from 0.965 to 0.970 g/cc, or any combination of two or more of these ranges. The functionalized polyolefin may have a melt index (12) of from 5 to 30 dg/min, such as from 5 to 10 dg/min, from 10 to 15 dg/min, from 15 to 20 dg/min, from 20 to 25 dg/min, from 25 to 30 dg/min, or any combination of two or more of these ranges. Suitable functionalized polyolefins include FUSABOND™ (available from The Dow Chemical Company, Midland MI) and POLYBOND™ (commercially available from SI Group, The Woodslands TX).

The first polyethylene may have a density of from 0.935 to 0.970 g/cc, such as from 0.940 to 0.970 g/cc, from 0.935 to 0.940 g/cc, from 0.940 to 0.945 g/cc, from 0.945 to 0.950 g/cc, 0.950 to 0.955 g/cc, from 0.955 to 0.960 g/cc, from 0.960 to 0.965 g/cc, from 0.965 to 0.970 g/cc, or any combination of two or more of these ranges. The first polyethylene may have a melt index (12) of from 10 to 50 dg/min, such as from 10 to 20 dg/min, from 20 to 30 dg/min, from 30 to 40 dg/min, from 40 to 50 dg/min, or any combination of two or more of these ranges. In some embodiments, the first polyethylene may be a high density polyethylene (HDPE). Generally, polymer blends comprising the first polyethylene having a density of from 0.935 to 0.970 g/cc result in synthetic shingles having improved rigidity. The first polyethylene may be a copolymer of ethylene and a C₄-C₈ α-olefin, such as butene, hexene, or octene. Suitable polyethylenes for use as the first polyethylene include DOW™ DMDA 8920 (available from The Dow Chemical Company, Midland MI).

The second polyethylene may have a density of from 0.905 to 0.935 g/cc, such as from 0.905 to 0.930 g/cc, from 0.905 to 0.910 g/cc, from 0.910 to 0.915 g/cc, from 0.915 to 0.920 g/cc, from 0.920 to 0.925 g/cc, from 0.925 to 0.930 g/cc, from 0.930 to 0.935 g/cc, or any combination of two or more of these ranges. The second polyethylene may have a melt index (12) of 3-10 g/10 min, such as from 3 to 4 g/10 min, from 4 to 5 g/10 min, from 5 to 6 g/10 min, from 6 to 7 g/10 min, from 7 to 8 g/10 min, from 8 to 10 g/10 min, or any combination of two or more of these ranges. In some embodiments, the second polyethylene may be a linear low density polyethylene. Generally, polymer blends comprising the second polyethylene having a density of 0.905-0.935 g/cc and a melt index (12) of 3-10 g/10 min result in synthetic shingles having improved rigidity. The second polyethylene may be a copolymer of ethylene and a C₄-C₈ α-olefin, such as butene, hexene, or octene. Suitable polyethylenes for use as the second polyethylene include DOWLEX™ (available from The Dow Chemical Company, Midland MI).

It should be understood that the above-described blends, or shingles produced therefrom, may further include one or more stabilizers, including viscosity stabilizers, hydrolytic stabilizers, primary and secondary antioxidants, ultraviolet light absorbers. Generally, these stabi lizers may help to protect both color and material properties against aging and UV damage. In embodiments, the blends, or shingles produced therefrom, may comprise from 0 to 40 wt. %, such as from 0 to 30 wt. %, from 0 to 20 wt. %, from 0 to 10 wt. %, from 1 to 40 wt. %, from 1 to 30 wt. %, from 1 to 20 wt. %, or from 1 to 10 wt. % of the stabilizer.

It should be understood that the above-described blends, or shingles produced therefrom, may further include one or more additives as known to those of skill in the art such as, for example, plasticizers, anti-static agents, dyes, pigments or other coloring agents, fire-retardants, lubricants, nucleating agent, reinforcing agents such as glass fiber and flakes, synthetic (for example, aramid) fiber or pulp, foaming or blowing agents, processing aids, slip additives, anti-block agents such as silica or talc, release agents, tackifying resins, or combinations of two or more thereof. In embodiments, the blends, or shingles produced therefrom, may comprise from 0 to 40 wt. %, such as from 0 to 30 wt. %, from 0 to 20 wt. %, from 0 to 10 wt. %, from 1 to 40 wt. %, from 1 to 30 wt. %, from 1 to 20 wt. %, or from 1 to 10 wt. % of additives.

As mentioned previously, the polymer blend may comprise the elastomeric component, the inorganic filler, the functionalized polyolefin, the first polyethylene, and the second polyethylene. In embodiments, the polymer blend may comprise at least 50 wt. %, at least 60 wt. %, at least 70 wt. %, at least 80 wt. %, at least 90 wt. %, at least 95 wt. %, at least 99 wt. %, or even at least 99.9 wt. % of the combined weight of the elastomeric component; the inorganic filler; the functionalized polyolefin; the first polyethylene: the second polyethylene: optionally, one or more stabilizers; and optionally, one or more additives.

In embodiments, the polymer blend may comprise from 1 to 45 wt. % of the elastomeric component, such as from 1 to 5%, from 5 to 10%, from 10 to 15%, from 15 to 20%, from 20 to 25%, from 25 to 30%, from 30 to 35%, from 35 to 40%, from 40 to 45%, from 5 to 25 wt. %, or any combination of two or more of these ranges.

In embodiments, the polymer blend may comprise from 40 to 70 wt. % of the inorganic filler, such as from 40 wt. %, from 45 wt. %, from 50 wt. %, from 55 wt. %, from 60 wt. %, from 65 wt. %, from 70 wt. %, or any combination of two or more of these ranges.

In embodiments, the polymer blend may comprise from 0.5 to 5 wt. % of the functionalized polyolefin, such as from 0.5 wt. %, from 1.0 wt. %, from 1.5 wt. %, from 2.0 wt. %, from 2.5 wt. %, from 3.0 wt. %, from 3.5 wt. %, from 4.0 wt. %, from 4.5 wt. %, from 5.0 wt. %, or any combination of two or more of these ranges.

In embodiments, the polymer blend may comprise from 5 to 40 wt. % of the first polyethylene, such as from 5 wt. %, from 10 wt. %, from 15 wt. %, from 20 wt. %, from 25 wt. %, from 30 wt. %, from 35 wt. %, from 40 wt. %, or any combination of two or more of these ranges.

In embodiments, the polymer blend may comprise from 5 to 40 wt. % of the second polyethylene, such as from 5 wt. %, from 10 wt. %, from 15 wt. %, from 20 wt. %, from 25 wt. %, from 30 wt. %, from 35 wt. %, from 40 wt. %, or any combination of two or more of these ranges.

In embodiments, the polymer blend may have a total instrumented dart impact (IDI) of at least 15 J, such as at least 18 J, at least 20 J, at least 21 J, at least 22 J, or at least 23 J, when measured at −20° C. In embodiments, the polymer blend may have a tensile elongation at break of at least 20%, such as at least 25%, at least 28%, at least 30%, at least 35%, or at least 37%, when tested according to ASTM D638 Type I.

In embodiments, the synthetic shingle formed from the polymer blend may have a generally planar shape with length, width, and thickness. In embodiments, the synthetic shingle may have a length of at least 10 cm, such as at least 15 cm, from 10 cm to 25 cm, from 15 cm to 25 cm, or any combination of two or more of these ranges. In embodiments, the synthetic shingles may have a thickness of at least 1 cm, such as from 1 to 5 cm, from 1 to 3 cm, or from 1.3 to 2.5 cm. In embodiments, the synthetic shingle may have a width of at least 10 cm, such as at least 15 cm, or at least 20 cm. In embodiments, the synthetic shingle may be textured on at least one surface.

The synthetic shingle may be formed from the polymer blend by any method, such as compression molding or injection molding.

### Test Methods

### Density

Samples for density measurement are prepared according to ASTM D 1928. Polymer samples are pressed at 190° C. and 30,000 psi for three minutes, and then at 21° C. and 207 MPa for one minute. Measurements are made within one hour of sample pressing using ASTM D792, Method B.

### Melt Index (I2)

Melt index, or 12, (grams/10 minutes or dg/min) is measured in accordance with ASTM D 1238, Condition 190° C./2.16 kg, Procedure B.

### Instrumented Dart Impact (IDI)

The Instrumented Dart Impact (IDI) method is based on ASTM D7192. In this method, a hemispherical probe (tup) of diameter 12.7 mm attached to a striker assembly is made to fall under gravity and impact a pneumatically clamped sample with the exposed area being a circular disc of diameter 76 mm. A CEAST 9350 drop-tower was employed for this purpose. The tup is equipped with a 22 kN strain-gauge load cell and connected to a striker weighing, in total, approximately 29 Kg. The load cell is located away from the tup thereby measuring the total vertical reaction force exerted by the film on the impactor. The software calculates the displacement of the striker, or the deflection of the film (or disk) sample at its center. The acceleration as a function of time is calculated from the measured force, acceleration of gravity, and the mass of the striker. The displacement is calculated from acceleration history, time, and initial velocity. The final output of this test method is the history of reaction force exerted on the probe by the film as a function of the deflection of the film under the tup. The peak force is the highest force on the load-displacement (LD) curve. The peak energy is the area under the load-displacement (LD) curve up to the peak force point. The total energy absorbed in the entire process is the area under the load-displacement (LD) curve of the entire process. By changing the drop-height, the impact velocity is controlled in this experiment. Unless otherwise specified, the impact velocity used in our experiments was 3.3 m/s. The instrument is equipped with a temperature-controlled-chamber in which the sample holder is housed, thereby allowing for testing at non-ambient temperatures. The test temperatures used were 23° C. (room temperature), 10° C., 0° C., −10° C. and −20° C. Test samples were conditioned at 23±2° C. and 50±10% relative humidity for at least 40 hours before conducting the test. Additionally, samples for sub-ambient testing were conditioned in freezers set at the desired temperature for at least 5 hours prior to testing. Tested and broken specimens were inspected visually for visible signs of ductility around the failure area and was marked as either ‘Ductile’ or ‘Brittle’ failure. Five specimens of each composition were tested. Average values of peak force, peak energy, and total energy were reported.

### Tensile Properties

Tensile properties (e.g., tensile elongation at break and tensile stress at break) are measured according to ASTM D638 at a 2 inch/min speed and 23° C. Injection molded ASTM type I bars were used for the tensile test. Five test samples (per composition) were measured, and the average values were reported.

### Flexural Modulus

2 percent secant flex moduli were measured according to ASTM D-790. Injection molded ASTM type I bars were used for the flexural modulus test at 23° C. A test speed of 0.05 in/min was chosen. Five test samples (per composition) were measured, and the average values were reported.

### Examples

The following examples illustrate features of the present disclosure but are not intended to limit the scope of the disclosure. The following experiments analyzed the performance of embodiments of the bimodal ethylene-based polymers described herein.

### Materials

DOW™ DMDA-8920 NT 7 is a high density polyethylene having a density of 0.950 g/cc and a melt index (12) of 20 g/10 min, and commercially available from The Dow Chemical Company (Midland, MI). DOW™ DMDA 8920 is a first polyethylene as that term is used herein.

DOWLEX™ 2035 is a linear low density polyethylene (LLDPE) having a density of 0.919 g/cc and melt index (12) of 6.0 g/10 min, and commercially available from The Dow Chemical Company (Midland, MI). DOWLEX™ 2035 is a second polyethylene as that term is used herein.

AFFINITY™ PL 1280G is a polyolefin plastomer produced using INSITE™ technology and having a density of 0.900 g/cc and a melt index (12) of 6.0 g/10 min, and commercially available from The Dow Chemical Company (Midland, MI).

ENGAGE™ 8200 is an ethylene-octene polyolefin elastomer having a density of 0.870 g/cc and a melt index (12) of 5 g/10 min., and commercially available from The Dow Chemical Company (Midland, MI).

FUSABOND™ E204 is an anhydride modified high density polyethylene having a density of 0.954 g/cc, a melt index (12) of 12 g/10 min., and a maleic anhydride graft level of >1% by weight, and commercially available from The Dow Chemical Company (Midland, MI). FUSABOND™ E204 is a functionalized polyolefin, as that term is used herein.

Atomite™ is an untreated ground calcium carbonate having an average diameter of 3 microns, and commercially available from IMERYS S.A. (Paris, Fr).

### Example Compositions

A series of examples were compounded using a Coperion 26 Mc18 twin screw extruder. The barrel assembly consists of 11-barrel blocks. Total extruder barrel length is 1125 mm. The barrel assembly is a 44/1 L/D. The extruder's barrel inner diameter is 26 mm. The weighed-out polymer blends were loaded into a K-Tron KXQ4. The polymer blends were fed into the extruder's main feed throat. The CaCO₃ was loaded into a K-Tron T-20 (KMC 3). The CaCO₃ was fed into the extruder's side arm feed throat. The side arm was attached to the MC18 at the 6th barrel block. During the compounding process, Nitrogen was injected at the extruder's main feed funnel and at the side arm's feed funnel. Both the extruder screw and side arm extruder screw were set at 200 rpm. The barrier temperature was set at 130 for zone 2 and 200° C. for zone 3 through zone 11. The melt temperature was about 211° C. Total throughput rate was 15 lbs/hour. Molten polymer compound was extruded thru a 2-hole die (4 mm diameter holes.) The polymer compound strands were submerged into a chilled water bath and pelletized using a Conair 304 strand pelletizer. Samples were nitrogen purged overnight to dry. The example compositions (in wt. %) are described in Table 1.

TABLE 1
Example Compositions

| | DOW ™ | | | | | |
|---|---|---|---|---|---|---|
| | DMDA- | | | | | |
| | 8920 | DOWLEX ™ | AFFINITY ™ | ENGAGE ™ | FUSABOND ™ | |
| | NT 7 | 2035 | PL 1280G | 8200 | E204 | ATOMITE ™ |
| CE-A | 20 | 20 | 5 | 0 | 0 | 55 |
| EX-1 | 18 | 20 | 5 | 0 | 2 | 55 |
| CE-B | 20 | 20 | 0 | 5 | 0 | 55 |
| EX-2 | 18 | 20 | 0 | 5 | 2 | 55 |
| CE-C | 15 | 0 | 30 | 0 | 0 | 55 |
| CE-D | 21 | 9 | 0 | 15 | 0 | 55 |
| EX-3 | 19 | 9 | 0 | 15 | 2 | 55 |

Test samples were injection molded utilizing a TOYO Si-90 injection molder and universal insert tools that allow different insert to be utilized to make ASTM Type I tensile bars and round disks (4 inch in diameter and 125 mil in thickness). The Type I tensile bars were used for tensile and flexural modulus measurements. The round disks were used for instrumented dart impact. The injection molding conditions are shown in the Table below.

TABLE 2
Injection Molding Conditions

| | | Type 1 | Round |
|---|---|---|---|
| Parameters | | tensile bars | disks |
| Temperatures (° C.) | Nozzle/Set Pt. | 200 | 200 |
| | Zone 4/Set Pt. | 204 | 204 |
| | Zone 3/Set Pt. | 204 | 204 |
| | Zone 2/Set Pt. | 175 | 175 |
| | Zone 1/Set Pt. | 121 | 121 |
| | Hopper/Set Pt. | 48 | 48 |
| Dosage Volume (mm) | | 63.25 | 61.5 |
| Inj-Hold Switch-Over Mode (mm) | | 15 | 15 |
| 1st Back-up Timer | | 5.5 | 5.5 |
| Injection Pressure (Bar) | | 2000 | 2000 |
| Hold Pressure (Bar) | | 175 | 200 |
| Cushion Volume (mm) | | 11.3 | 12.6 |
| Back Pressure (Bar) | | 15 | 15 |
| SuckBack/Decompression (mm) | | 5 | 5 |
| Temp (° C.) | TCU Set Point | 90 | 90 |
| | Chiller Set Point | 50 | 50 |
| Timers (sec) | Delay Injection | 0 | 0 |
| | Injection Time | 1.4 | 1.36 |
| | Holding Time | 25 | 25 |
| | Cooling Time | 20 | 20 |
| | Mold Open | 5.7 | 5.7 |
| | Plasticizing Time | 6.3-10 | 5.6-6.4 |
| Spd. (in/min) | Plasticizing Speed/ | 150 | 150 |
| | Screw Spd (rpm) | | |
| | Injection Speed (mm/s) | 40 | 40 |
| Cycle Time (sec) | | 56.3 | 56.3 |

Each of the examples described in Table 1 was then subjected to instrumented dart impact testing as is shown in Tables 3-6

TABLE 3
IDI Peak Energy

| | 23° C. | 10° C. | 0° C. | −10° C. | −20° C. |
|---|---|---|---|---|---|
| CE-A | 10.3 | 9.2 | 4.4 | 4.6 | 4.4 |
| EX-1 | 17.0 | 18.4 | 15.3 | 10.6 | 15.7 |
| CE-B | 10.2 | 10.6 | 4.5 | 2.9 | 3.4 |
| EX-2 | 17.7 | 19.6 | 20.3 | 22.9 | 16.6 |
| CE-C | 9.3 | 10.9 | 13.9 | 15.7 | 9.8 |
| CE-D | 9.8 | 11.4 | 13.0 | 9.2 | 5.8 |
| EX-3 | 17.7 | 20.5 | 23.8 | 26.1 | 24.3 |

Peak energy shown in Table 3 is provided in Joules. As can be seen from Table 3, the polymer blends described herein have improved peak dart impact energy, at all temperature ranges. However, the difference becomes even more pronounced at relatively low temperatures. CE-A is most similar to EX-1 yet EX-1 shows a peak IDI of over 3× the peak IDI of CE-A at −20° C.

TABLE 4
IDI Peak Force

| | 23° C. | 10° C. | 0° C. | −10° C. | −20° C. |
|---|---|---|---|---|---|
| CE-A | 1163 | 1224 | 1024 | 774 | 744 |
| EX-1 | 2021 | 2324 | 2368 | 2145 | 2691 |
| CE-B | 1164 | 1303 | 1046 | 714 | 697 |
| EX-2 | 1970 | 2295 | 2600 | 2894 | 2656 |
| CE-C | 1010 | 1225 | 1500 | 1708 | 1454 |
| CE-D | 1100 | 1297 | 1502 | 1525 | 1180 |
| EX-3 | 1741 | 2070 | 2478 | 2771 | 2744 |

Peak force in Table 4 is provided in Newtons. As can be seen from Table 4, the polymer blends described herein have improved peak dart impact energy, at all temperature ranges. However, the difference becomes even more pronounced at relatively low temperatures. CE-A is most similar to EX-1 yet EX-1 shows a peak IDI of over 3× the peak IDI of CE-A at −20° C.

TABLE 5
IDI Total Energy

| | 23° C. | 10° C. | 0° C. | −10° C. | −20° C. |
|---|---|---|---|---|---|
| CE-A | 19.6 | 17.5 | 11.0 | 8.4 | 9.8 |
| EX-1 | 24.3 | 25.1 | 23.8 | 19.7 | 24.0 |
| CE-B | 19.4 | 19.2 | 10.8 | 8.5 | 9.8 |
| EX-2 | 25.3 | 26.7 | 26.7 | 28.7 | 23.7 |
| CE-C | 20.4 | 22.6 | 24.0 | 24.9 | 17.7 |
| CE-D | 18.8 | 21.7 | 22.0 | 17.7 | 12.1 |
| EX-3 | 25.7 | 28.5 | 30.1 | 30.2 | 28.6 |

Total energy shown in Table 5 is provided in Joules. As can be seen from Table 5, the polymer blends described herein have improved total dart impact energy, at all temperature ranges. However, the difference becomes even more pronounced at relatively low temperatures. CE-A is most similar to EX-1 yet EX-1 shows a total IDI of over 2.4× the total IDI of CE-A at −20° C.

TABLE 6
IDI Failure Mode

| | 23° C. | 10° C. | 0° C. | −10° C. | −20° C. |
|---|---|---|---|---|---|
| CE-A | 5D | 5D | 5DB | 1DB, 4B | 1DB, 4B |
| EX-1 | 5D | 5D | 5DB | 5DB | 5DB |
| CE-B | 5D | 5D | 5DB | 3DB, 2B | 2DB, 3B |
| EX-2 | 5D | 5D | 1D, 4DB | 5DB | 5DB |
| CE-C | 5D | 5D | 5D | 5D | 4D, 1DB |
| CE-D | 5D | 5D | 4D, 1DB | 1D, 4DB | 5DB |
| EX-3 | 5D | 5D | 5D | 5D | 2D, 3DB |

D: ductile; B: brittle; DB: brittle/ductile composite failure.
“2D, 3DB” means 2 samples exhibited a ductile failure mode and 3 samples exhibited a brittle/ductile composite failure mode.
Total 5 samples were tested.

Additionally, the samples were tested for Flexural Modulus and Tensile properties, as is shown in Table 7.

TABLE 7
Flexural and Tensile Properties

| | 2% secant | 2% secant | Tensile | Tensile | Tensile | Tensile |
|---|---|---|---|---|---|---|
| | Flex | tensile | yield | yield | elongation | stress at |
| | modulus | modulus | strain | stress | at break | break |
| | (ksi) | (ksi) | (%) | (psi) | (%) | (psi) |
| CE-A | 130 | 100 | 1.7 | 1934 | 3 | 2046 |
| EX-1 | 131 | 105 | 8.2 | 2660 | 37 | 2326 |
| CE-B | 116 | 92 | 2.5 | 1946 | 6 | 1994 |
| EX-2 | 123 | 99 | 9.2 | 2562 | 52 | 2114 |
| CE-C | 77 | 61 | 4.8 | 1494 | 17 | 1320 |
| CE-D | 85 | 68 | 4.0 | 1664 | 10 | 1690 |
| EX-3 | 94 | 78 | 10.4 | 2012 | 204 | 1764 |

As can be seen from Table 6, the polymer blends described herein all experience tensile elongation at break above 30%. In contrast, the comparative examples all have a tensile elongation at break of less than 10%. As can be seen from Table 5, the improved tensile elongation at break of the polymer blends described herein results in more ductile failure than the comparative examples, which tend to experience brittle failures. Generally, brittle failure modes result in decreased longevity and resistance to impact when incorporated into a synthetic shingle.

1. A synthetic shingle formed from a polymer blend, the polymer blend comprising:
an elastomer, a plastomer, or both, the elastomer, the plastomer, or both having a density of from 0.855 to 0.905 g/cc;
an inorganic filler;
a functionalized polyolefin comprising:
a polyolefin grafted with ethylenically unsubstituted dicarboxylic acid or a derivative thereof; or
a polyolefin comprising at least one α-olefin copolymerized with ethylenically unsubstituted dicarboxylic acid or a derivative thereof;
a first polyethylene having a density of from 0.935 to 0.970 g/cc; and
a second polyethylene having a density of 0.905-0.935 g/cc and a melt index (I2) of 3-10 g/10 min.

2. The synthetic shingle of claim 1, wherein the polymer blend comprises:
from 1 to 45 wt. % of the elastomer, the plastomer, or both;
from 40 to 70 wt. % of the inorganic filler;
from 0.5 to 5 wt. % of the functionalized polyolefin;
from 5 to 40 wt. % of the first polyethylene; and
and from 5 to 40 wt. % of the second polyethylene.

3. The synthetic shingle of claim 1, wherein the second polyethylene has a density of from 0.905 to 0.930 g/cc.

4. The synthetic shingle of claim 1, wherein the first polyethylene is a high density polyethylene having a density of from 0.940 to 0.970 g/cc.

5. The synthetic shingle of claim 1, wherein the synthetic shingle comprises from 5 to 25 wt. % of the elastomer, the plastomer, or both.

6. The synthetic shingle of claim 1, wherein the elastomer and/or plastomer has a melt index of from 1 to 20 g/10 min.

7. The synthetic shingle of claim 1, wherein the inorganic filler is CaCO 3.

8. The synthetic shingle of claim 1, wherein the functionalized polyolefin is an anhydride functionalized polyolefin.

9. The synthetic shingle of claim 8, wherein the anhydride functionalized polyolefin is a maleic anhydride functionalized polyolefin.

10. The synthetic shingle of claim 9, wherein the maleic anhydride functionalized polyolefin is a maleic anhydride grafted polyethylene.

11. The synthetic shingle of claim 1, wherein the functionalized polyolefin has a density of from 0.940 to 0.970 g/cc and a melt index (12) of from 5 to 30 dg/min.

12. The synthetic shingle of claim 1, wherein the first polyethylene has a melt index (I2) of from 10 to 50 dg/min.

13. The synthetic shingle of claim 1, wherein the synthetic shingle has a planar shape with a length of at least 10 cm, a width of at least 10 cm, and a thickness of from 1 to 5 cm.

14. The synthetic shingle of claim 1, wherein the polymer blend has a total IDI energy of at least 20 J at −20° C.

15. The synthetic shingle of claim 1, wherein the polymer blend has a tensile elongation at break of at least 30%, when tested according to ASTM D638 Type I.
